(19) United States
(12) Patent Application Publication
(10) Pub. No.: US 2004/0069769 A1
(43) Pub. Date: Apr. 15, 2004

(54) Load sensing and over-temperature control for a resistive heating device

(76) Inventor: Sheldon P. Carr, West Bend, WI (US)

Correspondence Address: Andrew S. McConnell, Boyle, Fredrickson, Newholm, Stein & Gratz, S.C., Suite 1030, 250 E, Wisconsin Avenue, Milwaukee, WI, 53202, US

(21) Appl. No.: 10/269,637

(22) Filed: Oct. 11, 2002

(51) Int. Cl. H05B 1/02

(52) U.S. Cl. 219/497

(57) ABSTRACT

A resistive heating device, such as an electric blanket, heating pad or throw, includes one or more resistive heating elements supplied with power from a power supply. The one or more resistive heating elements are constructed of a material which varies in resistance in proportion to variations in temperature. A controller is interconnected with the power supply for controlling operation of the power supply, to control the amount of power supplied to the resistive heating load and thereby the heat generated by the resistive heating load. A load sensing arrangement is interconnected with the controller and with the power output of the power supply. The load sensing arrangement is operable to detect the presence of the one or more resistive heating elements as well as the resistance of the one or more resistive heating elements. In the event resistance of the one or more heating elements exceeds a predetermined threshold corresponding to a predetermined maximum temperature of the one or more resistive heating elements, or in the event the one or more resistive heating elements are disconnected from the power supply, the load sensing arrangement is operable to discontinue the supply of output power to the one or more resistive heating elements by disabling the controller. The controller must then be reset to an off condition when the one or more resistive heating elements are subsequently connected to the power supply to resume operation.

### BACKGROUND AND SUMMARY OF THE INVENTION

This invention relates to a resistive heating device such as an electric blanket, heating pad or throw, and more particularly to a system for discontinuing the supply of power to the resistive heating device in the event of disconnection of the resistive heating device from a power supply or in response to an over-temperature condition.

In a resistive heating device such as an electric blanket, heating pad or throw, a power supply arrangement is operable to supply electrical energy to one or more resistive heating elements, such as heating wires, incorporated in the blanket, pad or throw. In the event the blanket, pad or throw is improperly folded or bunched, or is placed between other blankets, the temperature of the electric blanket can increase significantly and result in product failure. In addition, in a construction in which the electric blanket can be disconnected from the power supply, it is advantageous to have the power supply automatically turn off and to prevent its operation until the electric blanket is reconnected to the power supply.

It is an object of the present invention to provide a resistive heating device having a resistive heating element that is supplied with power from a power supply controlled by a controller, in which the supply of power to the resistive heating element is discontinued in the event the temperature of the resistive heating element exceeds a predetermined threshold or in the event the resistive heating element is disconnected from the power supply. It is a further object of the invention to provide such a resistive heating device in which the power supply includes a power conversion arrangement that provides low voltage output power to the resistive heating element from high voltage input power. It is a further object of the invention to provide such a resistive heating device in which the controller is used to discontinue the supply of power to the resistive heating element in response to an over-temperature condition or when the resistive heating element is disconnected. It is a further object of the invention to provide such a resistive heating device in which operation of the power supply can only be resumed after an over-temperature or load disconnection condition after first returning the controller to an off condition.

In accordance with the present invention, a resistive heating device includes a power supply having a power output, and one or more resistive heating elements interconnected with the power output. A controller is interconnected with the power supply for controlling operation of the power supply. A load sensing arrangement is interconnected with the controller and with the power output of the power supply. The load sensing arrangement is operable to detect the resistance of the one or more heating elements, and is operable to discontinue the supply of power to the one or more resistive heating elements when the resistance of the one or more heating elements, which corresponds to a predetermined high temperature threshold, exceeds a predetermined threshold of resistance. The one or more resistive heating elements are interconnected with the power output of the power supply via a removable connection arrangement, and the load sensing arrangement is further operable to sense the connection of the one or more resistive heating elements to the power supply. The load sensing arrangement is operable to enable operation of the controller when the one or more resistive heating elements are connected to the power output of the power supply, and to prevent operation of the controller in the event the one or more resistive heating elements are disconnected from the power output of the power supply.

The power supply may be in the form of a low voltage power supply that includes a power conversion device such as a transformer, which converts high voltage input power and supplies low voltage output power to the power output, which is electrically isolated from the high voltage input power. The controller is interconnected with the low voltage power output of the power supply by means of a low voltage controller power input, and the load sensing arrangement is interconnected with the low voltage controller power input to cut off the supply of power to the controller in the event the resistance of the one or more heating elements exceeds a predetermined threshold or in the event the one or more heating elements are disconnected from the power output of the power supply.

The one or more resistive heating elements are preferably in the form of heating elements that change resistance in proportion to a change in temperature. In one form, the one or more resistive heating elements are in the form of a heating wire that has positive temperature characteristics (PTC), which provide an increase in resistance as the temperature of the wire increases. The increase in resistance results in a decrease in current supplied to the heating wire. The load sensing arrangement includes a voltage reference, and current supplied to the heating wire is also supplied to a resistive load that provides a voltage drop that corresponds to the temperature of the heating wire. The current load of the heating wire results in voltage drop that is compared to the reference voltage. As temperature of the heating wire rises, resistance increases and current decreases such that, when the voltage drop decreases to a predetermined threshold when compared to the voltage reference, the supply of power to the controller is discontinued so as to limit the prevent any further temperature rise of the heating wire, so that the temperature of the heating wire is limited to a predetermined safe value.

The invention further contemplates an improvement in a resistive heating device as well as a method of controlling operation of a resistive heating device, substantially in accordance with the foregoing summary.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view showing the components incorporated in a representative resistive heating device, such as an electric blanket, heating pad or throw, which includes a power supply and the load sensing and over-temperature protection features of the present invention;

FIG. 2 is a partial top plan view showing the housing for the power supply of FIG. 1;

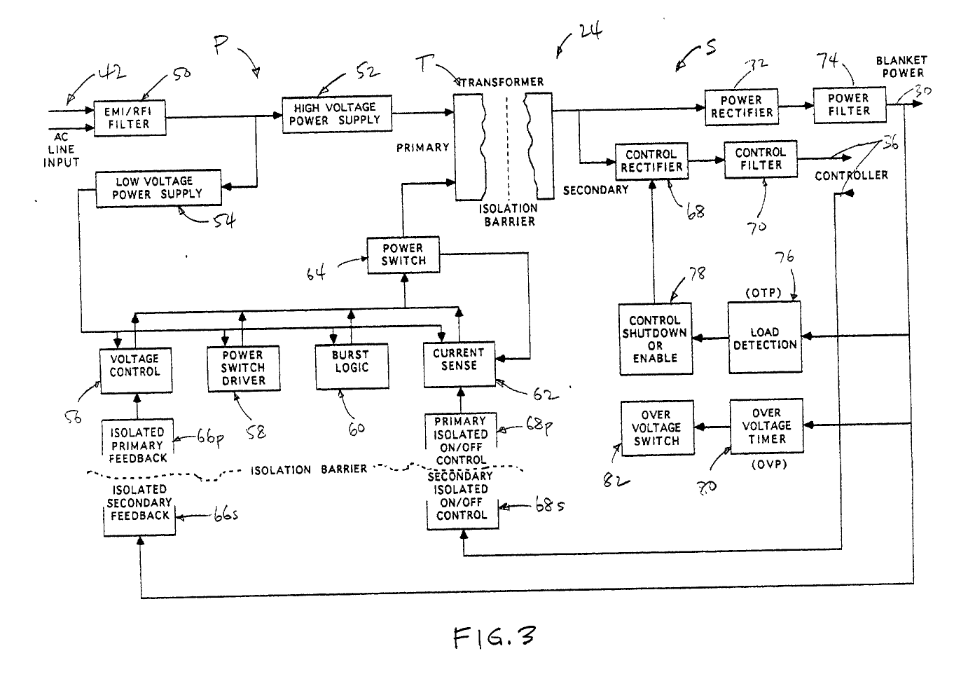

FIG. 3 is a block diagram showing the components incorporated into the power supply of FIG. 1;

FIG. 4 is a schematic diagram showing the electronic components that comprise the components of the power supply shown in FIG. 3;

FIG. 5 is a schematic diagram showing the secondary side of the power supply of FIG. 4, to illustrate the over-temperature and load sensing features of the present invention incorporated into the power supply;

FIGS. 6 and 7 is are views showing a circuit board for mounting the electronic components of the power supply as shown in FIG. 4, and including an over-voltage protection circuit for use therewith; and

FIG. 8 is a schematic diagram showing the components of the over-voltage protection circuit incorporated into the components of the power supply as shown in FIGS. 6 and 7.

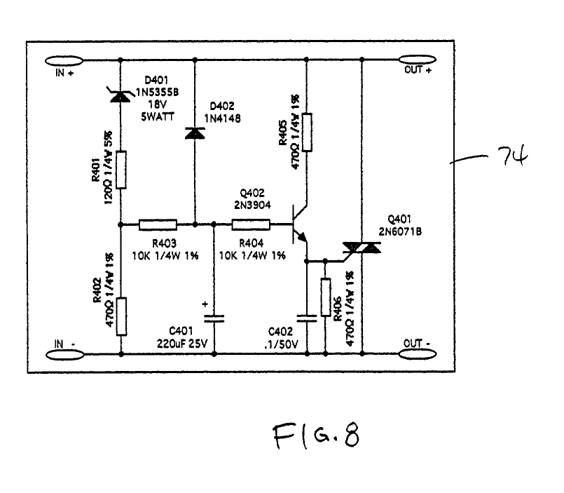

### DETAILED DESCRIPTION OF THE INVENTION

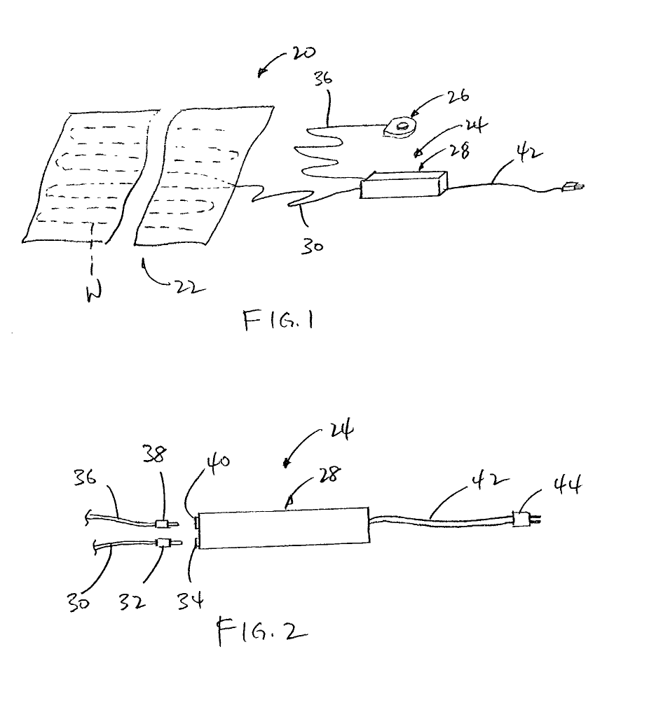

Referring to FIG. 1, an electrical device, illustrated as an electric blanket, heating pad or throw shown generally at 20, consists of an electrical load in the form of a blanket portion 22 having a heating wire W, a power supply 24 and a controller 26. Power supply 24 includes a housing 28 within which the components of power supply 24 are contained. A connection cable 30 extends from blanket portion 22, and includes a connector 32 at its opposite end that is adapted for selective connection to a power output receptacle 34 incorporated in power supply 24. Similarly, controller 26 includes a connection cable 36 having a connector 38 at its opposite end adapted for selective engagement with a controller receptacle 40 incorporated in power supply 24. A power input cord 42 extends from power supply 24, and includes a plug 44 at its end for engagement with a wall outlet or the like, to supply conventional 110 VAC 60 Hz power to power supply 24. In a manner to be explained, power supply 24 converts the 110 VAC input power from power supply cord 42 into low voltage output power that is supplied to blanket portion 22 as well as to controller 26, for controlling the operation of power supply 24 to control the output of power to blanket portion 22.

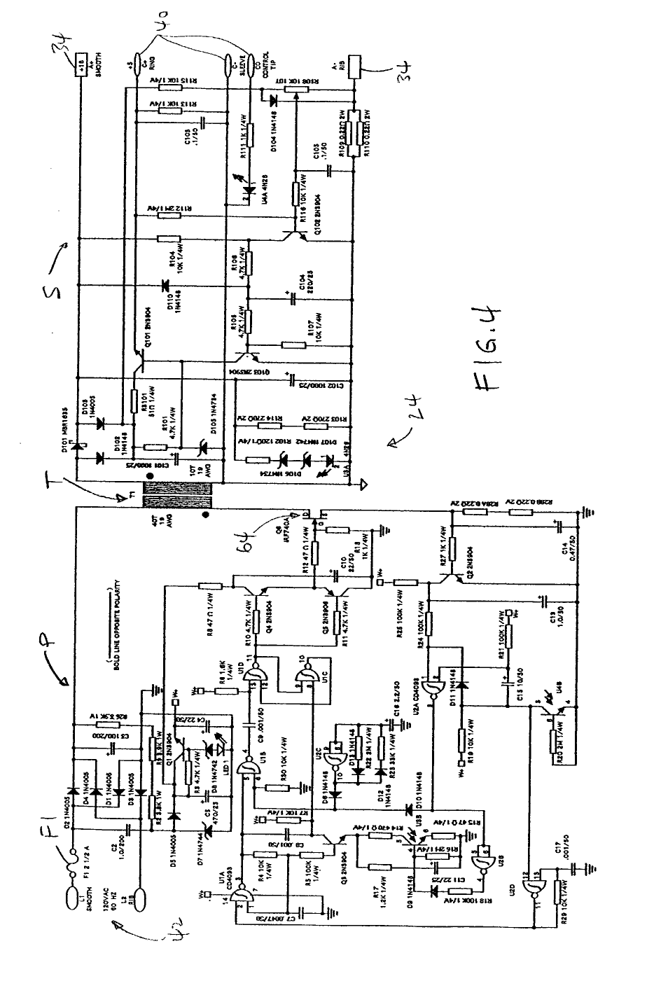

FIG. 3 illustrates in block form the components incorporated in power supply 24. Generally, power supply 24 is divided into a high voltage primary side P and a low voltage secondary side S. High voltage power, such as 110 volt AC power, is supplied to the input of primary side P from electrical cord 42 to an EMI/RFI filter 50, which eliminates conducted and emitted radio frequency interference. From EMI/RFI filter 50, high voltage power is supplied to a high voltage power supply 52, which is connected to the primary side of a transformer T.

In a manner as is known, transformer T has a primary winding that is electrically isolated from a secondary winding, to establish an isolation condition such that voltage generated on the secondary winding is not connected to the primary input line voltage.

Primary side P further includes a low voltage power supply 54 which receives high voltage power from EMI/RFI filter 50, and which is interconnected with the remaining components of primary side P which function to provide selective operation of transformer T to generate low voltage output power for supply to secondary side S. Specifically, low voltage power supply 54 is connected to a voltage control circuit 56, a power switch driver circuit 58, a burst logic circuit 60 and a current sensing circuit 62, all of which provide inputs to a power switch circuit 64 which in turn provides an output to current sensing circuit 62. Power switch circuit 64 is interconnected with the high voltage primary side of transformer T, and functions to control operation of transformer T to generate low voltage power in secondary side S. In addition, primary side P includes an isolated primary feedback 66P and an isolated primary on/off control 68P. Secondary side S includes an isolated secondary feedback 66S that is associated with and isolated from primary feedback 66P, and a secondary isolated on/off control 68S that is associated with and isolated from primary isolated on/off control 68P.

The secondary low voltage side of transformer T provides low voltage output power to the isolated secondary side S of power supply 24. Low voltage power is supplied from the output of transformer T to a low voltage control circuit consisting of a control rectifier 68 and a control filter 70, which in turn provides output power to controller 26 through connector 38 and cable 36. Low voltage power from the output of transformer T is also supplied through a power rectifier 72 and a power filter 74 to blanket portion 22 through blanket portion cable 30 and its associated connector 32.

Low voltage power from power filter 74 is supplied to isolated secondary feedback 66S. Inputs from controller 26 are supplied to secondary isolated on/off control 68S. In addition, secondary side S includes a load detection circuit 76, which in turn is connected to a control shutdown/enable circuit 78 that in turn is interconnected with control rectifier 68. Low voltage output power is also supplied from power filter 74 to an over-voltage timer circuit, which is interconnected with an over-voltage switch circuit 82.

Generally, high voltage power supplied to the high voltage primary side of transformer T is converted by transformer T to low voltage power which is supplied to the secondary side of transformer T, in response to operation of power switch 64. Voltage control circuit 56 acts as a pulse width generating circuit. The feedback control provided by isolated secondary feedback 66S and isolated primary feedback circuit 66P, is operable to provide feedback to modulate the outputs of voltage control circuit 56, which in turn controls the duty cycle of power switch 64 to control the amount of power output to the isolated secondary of transformer T.

Burst logic circuit 60 functions to output a short high level enable logic with a long low logic duty cycle when controller 26 is off. Each short high level enables the power switch 64. The high oscillation override frequency from burst logic circuit 60 functions to store a negligible amount of energy in transformer T, and provides low voltage auxiliary power to controller 26 to enable operation of controller 26 at startup. Controller 26, in turn, provides on/off commands to control the duty cycle of power switch 64.

Current sensing circuit 62 detects the connection of blanket heating cable 30 to the output of transformer T. Current sensing circuit 62 enables a fundamental frequency oscillator of primary side P and disables the higher oscillation frequency output by burst logic circuit 60 when controller 26 is turned on, and latches in an on condition to provide operation of power switch 64 when blanket power wire 30 is plugged in.

Load detection circuit 76 detects when the resistance of blanket portion wires W reach or exceed a predetermined threshold, or when blanket portion 22 is removed by disengagement of cable connector 32 from receptacle 34. When this occurs, load detection circuit 76 shuts down controller 26 to cut off the supply of power to secondary side S as well as heat to blanket wire W. Power cannot be restored until the blanket portion wire W cools and burst logic circuit 60 applies energy to controller 26 as described previously.

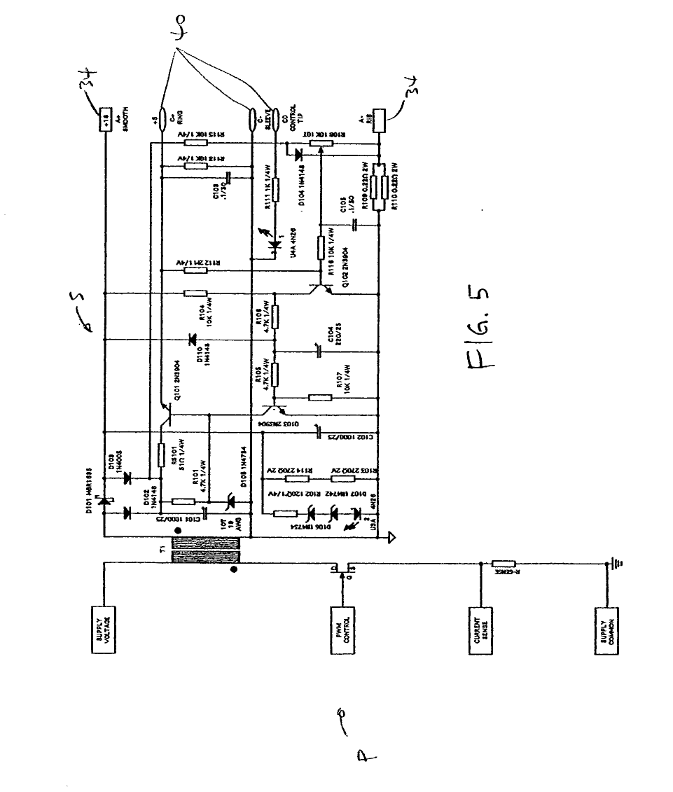

The schematic diagram of FIG. 4 illustrates electronic circuitry that makes up the components of the power supply as shown in FIG. 3. It should be understood that the illustrated and described embodiment is one of any number of ways to carry out the functions of the power supply components illustrated in FIG. 3.

Input high voltage power from cord 42 is supplied to primary side P at L1 and L2. In a manner to be explained, primary side P and transformer T interact to supply low voltage electrical power to secondary side S, such that secondary side S may representatively qualify as a Class 2 (UL) power supply having maximum values of 33 volts and 3 amps.

Low voltage power supply 54 of primary side P supplies power to the remaining components of primary side P at power supply connection W+. Diodes D1, D2, D3 and D4, in combination with capacitor C3 make up a capacitor input full wave power supply in which input voltage is full wave rectified and filtered 120 volt AC. Capacitor C3 is connected to the isolated secondary of transformer T, such that stored voltage on capacitor C3 is used for power conversion to transformer T. The remaining components of low voltage power supply 54, namely resistors R2, R9 and R26, diodes D5, D7, D8 and LED 1, capacitors C4 and C5, resistor R3 and transistor Q1 provide a filtered, clean and stable voltage power source for the circuitry of primary side P. Capacitor C2 provides a current boost to the stable voltage source.

Primary side P includes a fundamental frequency oscillator section incorporated in voltage control circuit 56 that provides a pulsed output at a predetermined frequency. The fundamental frequency oscillator includes a NAND gate U1A in combination with a capacitor C7 and a resistor R4. NAND gate U1A oscillates at a specific “carrier” or fundamental frequency, which may representatively be 30 kHz. The output from NAND gate U1A is supplied to a set-reset flip flop through NAND gate U1B, which acts as an inverter. The set-reset flip flop is a cross coupled flip flop made up of NAND gates U1B and U1C. NAND gates U1A and U1B, which are 180° out of phase, set and reset with a short pulse, to edge trigger NAND gates U1C and U1D, which make up the flip flop. The edge pulse from NAND gate U1A is directed through capacitor C8 to NAND gate U1C, to set the current latch. The output of NAND gate U1D is connected through resistors R10 and R11 to transistors Q4 and Q5. Without feedback control, the output at NAND gate U1D is approximately a 50-50 duty cycle.

Voltage control circuit 56 is controlled by isolated primary feedback circuit 66P and isolated secondary feedback circuit 66S, which accomplish modulation of the duty cycle of voltage control circuit 56. Isolated primary feedback circuit 66P consists of phototransistor U3B, transistor Q3, and resistors R5, R17, R14, R15 and R16, which cooperate with NAND gate U1C to accomplish modulation of the duty cycle. Capacitor C7, which is part of oscillator the fundamental frequency oscillator, controls the fundamental frequency from NAND gate U1A and also feeds the base of transistor Q3 through resistor R5.

Threshold voltage is set on the emitter of transistor Q3 of primary side P with the feedback from isolated secondary feedback circuit 66S through isolated primary feedback circuit 66P, which include respective associated phototransistors U3A (located on secondary side S) and U3B located on primary side P. As output voltage in secondary side S increases, phototransistor U3B begins to conduct, and to thereby hold the emitter of transistor Q3 to ground. This functions to decrease the reset threshold through capacitor C7 and resistors R4 and R5, and the power pulse is terminated by the collector of transistor Q3 in combination with resistor R7 and NAND gate U1C. As voltage increases on secondary side S, the voltage is fed through two series zener diodes D106 and D107 and through current limiting resistor R102, to set threshold voltage to turn on phototransistor U3A. If voltage on secondary side S exceeds voltage in isolated primary feedback circuit 66P, current runs through the IRED LED of phototransistor U3A to turn on associated phototransistor U3B on primary side P, which reduces the voltage. Voltage in phototransistor U3A is reduced so as to reduce the amount of current, and the zener diode network in the IRED of phototransistor U3A reduces the threshold, such that voltage goes back up. Eventually, an equilibrium is reached and a specific voltage is maintained which, in a manner to be explained, is the voltage that provides the appropriate current and heat in blanket portion 22 according to the setting of controller 26. Resistor R17 and capacitor C11 provide circuit compensation and stability in isolated primary feedback circuit 66P, to provide filtering so that changes in output are filtered and to provide a smooth DC output. Resistor R17 and capacitor C11 make up a high pass filter. Resistor R16 provides a high resistance path for the base of phototransistor U3B to ground. With this arrangement, the association of phototransistors U3A on secondary side S and U3B on primary side S make up a feedback loop which controls the duty cycle of power switch 64.

The output from the set-reset flip flop (pin 11 of NAND gate U1D) is supplied through resistors R10 and R11 and is current buffered by transistors Q4 and Q5 to drive power switch Q6. During the time period that power switch Q6 is on, energy is stored in transformer T, which in the illustrated embodiment is a flyback-type transformer. In this manner, when power switch Q6 is turned off, energy stored in transformer T transfers to secondary side S, in accordance with known operation. While transformer T is illustrated and described as a flyback-type transformer, it is also understood that the transformer could be of any other design that functions to isolate and supply energy to secondary side S, such as a buck boost design or a push-pull design.

Power from secondary side S is supplied to heating wire W of blanket portion 22 from output terminals A+ and A−, which are associated with power output receptacle 34 for engagement by connector 38. Controller 26 is connected to secondary side S at terminals C+, C− and C0, which are associated with controller receptacle 40 for engagement by connector 38.

In order to initiate operation of the power supply in response to an on signal received from controller 26, which is connected to secondary side S, it is necessary to transfer power from primary side P to secondary side S in order to turn on power supply 24. To accomplish this, primary side P includes burst logic circuit 60 that includes a short pulse network and a high frequency override oscillator network. Together, the short pulse network and override oscillator network, which runs at approximately 4 to 5 times the fundamental frequency, make up a timed burst and limited power oscillator. Pin 10 of NAND gate U2C is a short high level enable logic with a long low logic duty cycle. Each short high level enables drive circuit U1C, U1D. The high speed oscillation of the override oscillator network overrides the lower fundamental frequency of the fundamental frequency oscillator (U1A). The high oscillation override frequency limits the amount of energy stored in transformer T upon operation of the short pulse network and override oscillator network. Because of the association between NAND gates U2C and U2D, the enablement of the drive circuit (U1C, U1D) by the short pulse network allows the high frequency of the override oscillator network to operate power switch Q6 on and off at a very high frequency for a short period of time, to provide equalized pulses or bursts of energy through transformer T to control rectifier 68, which supplies power to terminal C+, and thereby to controller 26. The auxiliary power supply network consists of diodes D101, D102, D103 and D105, resistors R101 and RS101 and transistor Q101, which together provide 5 volt auxiliary power to controller 26. The burst energy functions to charge capacitor C101, which has a 5 volt output that is supplied through control connection C+ to controller 26 and which is returned from controller 26 through connection C0 to turn on secondary side S by applying the 5 volt power through resistor R111 and phototransistor U4A, which is associated with phototransistor U4B on primary side P. In this manner, when phototransistor U4A LED is forward biased, phototransistor U4B is turned on so as to pull the collector of phototransistor U4B to ground. This functions to disable the high frequency override oscillator network by grounding pin 12 of NAND gate U2D. Simultaneously, pin 3 of NAND gate U2A goes high, which again enables inverter NAND gate U1B, to turn on the PWM network of voltage control 56 and isolated primary feedback circuit 66P, to provide regulation of the duty cycle of power switch 64 and thereby the energy output by transformer T and supplied to blanket portion 22 through connections A+ and A−.

Current sensing circuit 62, which consists of resistors R25, R27, R28A and R28B in combination with capacitors C13 and C14 and transistor Q2 on primary side P, function to ensure the supply of power to blanket portion connections A+ and A− as long as blanket portion 22 remains connected. The connection of blanket portion 22 to output connections A+ and A− functions to draw current out of transformer T, and resistors R28A and R28B function to sense the energy in current through power switch Q6. During normal operation, transistor Q2 conducts and NAND gate U2A goes high, which enables the fundamental frequency oscillator (U1A). Phototransistor U4B on primary side P, which is associated with phototransistor U4A on secondary side S, detects the presence of an on signal from controller 26, to enable phototransistor U4B to conduct. Pin 12 of NAND gate U2D provides an output logic high at pin 1, so as to enable the fundamental frequency oscillator (U1A) and to disable the high frequency override oscillator network. Simultaneously, pin 2 of NAND gate U2A is pulled low, to enable the output pin 11 of NAND gate U1D. At the time of the initial on signal at phototransistor U4B, if blanket portion 22 is attached, the collector of phototransistor U4B goes to a logic low through the current of resistors R28A and R28B, such that current sensing network 48 is latched to remain on.

In the event blanket portion 22 is disconnected from power supply housing 24, the circuit of secondary side S is opened which results in transistor Q2 on primary side P immediately turning off due to the preset voltage drop across resistors R28A and R28B. Capacitor C13 functions to provide a slight delay to accommodate a temporary line bump open circuit condition. Upon disconnection of blanket portion 22, the input at pin 1 of NAND gate U2A goes high. Pin 2 of NAND gate U2A is high due to the charge from capacitor C15, which results in the output of NAND gate U2A going low. When this occurs, the fundamental frequency oscillator (U1A) is disabled, which shuts down primary side P and thereby secondary side S, to cut off the supply of power. In addition, this feature requires the connection of blanket portion 22 to secondary side S before the power supply system can be operated.

Controller 26 provides the on/off commands that are interpreted by phototransistor U4B on primary side P via the associated phototransistor U4A on secondary side S, in combination with resistor R111, which in turn controls the duty cycle of power switch Q6, as discussed previously. The commands from the controller are logic high and low duty cycle. High duty cycle logic commands increase the ratio of on to off of power switch Q6, to increase blanket temperature. Lower duty cycle commands decrease the blanket temperature by decreasing the ratio of on to off of power switch Q6. Phototransistor U4A operates in response to inputs from controller 26 through terminal C0 to feed back to the PWM control of primary side P in a variable duty cycle, to turn power supply 24 on and to verify that blanket portion 22 is connected. Current sensing circuit 62 is operable to latch power switch Q6 on, and at the same time is operable to verify that wire W of blanket portion 22 is not in an over-temperature condition. Phototransistor U4A then functions in response to the inputs from controller 26 to interact with phototransistor U4B to turn power switch Q6 on and off according to the desired duty cycle.

During the time that secondary side S is on, as controlled by controller 26 and phototransistor U4A, electrical power is output to blanket portion 22 through connectors A+ and A−. Energy output to connectors A+ and A− is filtered and stored by capacitor C102. Voltage output applied to connectors A+ and A− is limited and regulated by diodes D106 and D107 in combination with phototransistor U3A and pre-load resistors R103 and R114, which make up isolated secondary feedback circuit 66S. As voltage across isolated secondary feedback network 66S increases, phototransistor U3A on primary side P conducts due to its association with phototransistor U3A on secondary side S, which lowers the voltage output of secondary side S. Conversely, as voltage in isolated secondary feedback network decreases, phototransistor U3B on primary side P lacks conduction, which raises the voltage output of secondary side S until equilibrium is reached. A compensation network, consisting of resistor R17 and capacitor C11 on primary side P, function to provide equilibrium stability.

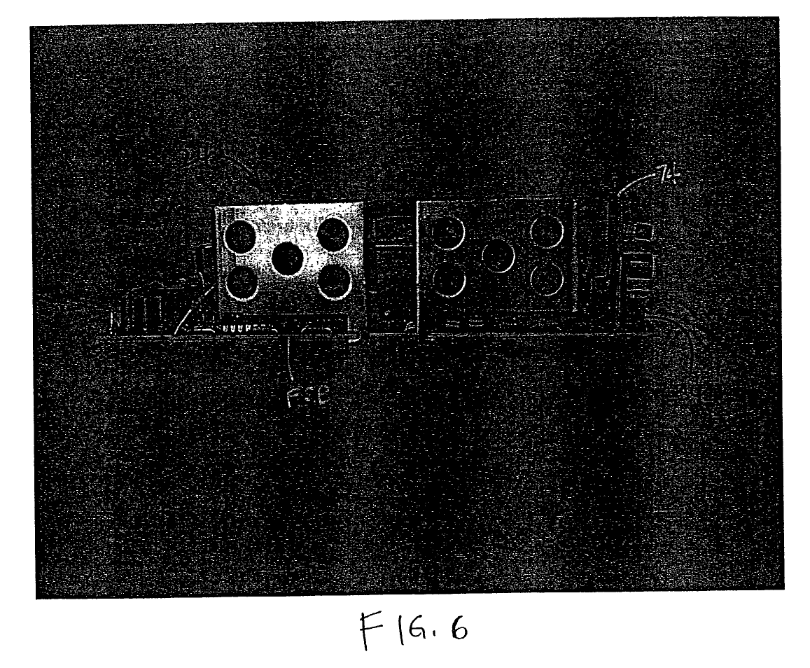

Referring to FIG. 5, secondary side S includes an over-temperature detection circuit which functions to control operation of transistor Q101. The heating wire W of blanket portion 22 has a positive temperature coefficient (PTC), such that the resistance of heating wire W increases and current in heating wire W is reduced, in proportion to an increase in the endothermic temperature change of heating wire W. Representatively, heating wire W may be formed of a material such as copper having a gauge selected to provide the desired positive temperature coefficient according to the length of heating wire W incorporated in blanket portion 22. Current to wire W is sensed through parallel resistors R109 and R110. A voltage drop across resistors R109 and R110 is fed to transistor Q102 through a resistor R116 via capacitor C105. Because connectors A+ and A− apply a stable voltage to wire W, as wire W heats endothermically, resistance increases and the current decreases, resulting in a decrease in the voltage drop across resistors R109 and R110. Resistor R115 and diode D104 make up a voltage reference, in which adjustable resistor R108 across the voltage reference. The adjustment voltage of resistor R108, added to the voltage drop across parallel resistors R109 and R110, maintains transistor Q102 on if the current is high and the resistance of wire W is low, meaning that the temperature of blanket portion 22 is within predetermined limits. As the temperature of blanket portion 22 rises due to endothermic heating of wire W, the resistance of wire W increases which results in a decrease in current of wire W, causing a decrease in the voltage drop across resistors R109 and R110. When the resistance of wire W reaches a predetermined threshold, the voltage drop across resistors R109 and R110 results in transistor Q102 turning off, which turns transistor Q103 on through resistor network R104, R105 and R106. When transistor Q103 is in an on condition, transistor Q101 is turned to an off condition which removes power or logic from controller 26 through control terminal C+. Such removal of logic from control terminal C+ disables the signal used to maintain the supply of power to blanket heating wire W, as described previously. Power supply 24 is thus shut down. Power to blanket portion 22 cannot be restored until wire W cools and a signal is sent to phototransistor U4A and resistor R111 through control input C0.

Capacitor C104 functions as a power on delay which allows transistor Q103 to remain off while transistor Q101 remains on. This momentary delay allows power to be applied to blanket heating wire W for a check of the current and therefore the endothermic temperature of heating wire W.

Resistor R112 is a positive feedback network to provide circuit snap action. Diode D110 discharges capacitor C104 at the moment power applied to blanket heating wire W is cut off, which provides a reset of the heating wire current check system.

It should be understood that the over-temperature protection circuit incorporated in secondary side S may be used in connection with any type of power supply, and is not limited to use in a power supply having the specific construction and operation as shown and described. Further, while the over-temperature detection circuit makes use of positive temperature characteristics of wire W, it is understood that reverse logic can be used if wire W is selected to have negative temperature coefficient characteristics.

It can thus be appreciated that the above-described over-temperature protection circuit also functions to shut down controller 26 and thereby power supply 24 in the event blanket portion 22 is removed from its connection to power supply 24. When blanket portion 22 is removed, the resistance experienced by secondary side S immediately becomes infinite, which has the same effect as an increase in the resistance of blanket heating wire W above the predetermined threshold, to trigger operation of the over-temperature detection circuit to cut off the supply of power to controller 26. As noted previously, the cut off of supply to controller 26 shuts down power supply 24, which can subsequently be restarted by reconnecting blanket portion 22 and initiating operation of the power supply via controller 26 as discussed above.

When power to the microprocessor of controller 26 is cut off in this manner, the controller microprocessor does not automatically turn itself back on when the 5 volt auxiliary power to controller 26 is restored because the microprocessor has been turned off. In order to restart, the power button of controller 26 must be actuated in order to restore operation of power supply 24.

In the event of an over-temperature condition or a condition in which blanket portion 22 is disengaged from the controller, capacitor C104 on secondary side S discharges through diode D110, to provide a power-up reset and a 5 volt pulse controller 26 through transistor Q103. The 5 volt pulse functions to both check the balance of controller 26 and to provide a power-up reset. In this manner, when the power supply cycles on and off with the control it is also charging capacitor C104 so that each new cycle is unique, and also provides continuous reset of the over-temperature protection circuit.

Resistor R112 is a positive feedback that provides snap action when the threshold is reached. Capacitor C103 and resistor R113 provide a filter network for the common and +5 volt connections C+ and C−, respectively. Capacitor C102 is a high energy capacitor that feeds the load of blanket portion 22 by being charged on flyback from transformer diode D101, which is a high speed current diode that rectifies the output of transformer T.

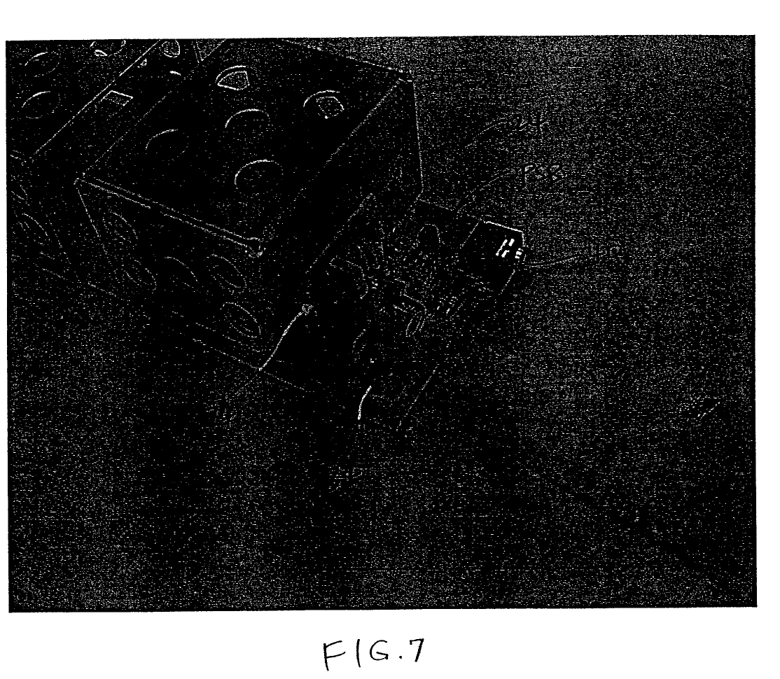

The invention also contemplates an over-voltage protection arrangement, which is plugged into the circuit board that contains the electronic components of power supply 24 as shown in FIG. 4. The over-voltage protection feature consists of an over-voltage protection board 74 which ensures that power output to blanket portion 22 through terminals A+ and A− does not exceed a low voltage power supply threshold, e.g. 33 volts. FIGS. 5 and 6 show over-voltage protection circuit board 74 plugged into the power supply circuit board, shown at PSB. Preferably, over-voltage protection circuit board 74 is inserted in a slot or other interruption in the circuitry that supplies output power to power output receptacle 34, to prevent the supply of power to power output receptacle 34 in the event that over-voltage protection circuit board 74 is not installed in the slot in power supply board PSB.

FIG. 7 shows the circuitry of the over-voltage protection circuit incorporated in over-voltage protection circuit board 74. Voltage is applied across connections IN+ and IN−. A zener diode D401 functions to subtract a predetermined voltage, e.g. 18 volts, from the IN+ connector and the balance is divided between resistors R401 and R402. If the voltage at the junction of resistors R401, R402 and R403 is at or below a predetermined threshold, then transistor Q402 conducts. Transistor Q401 is a triac that functions as a current amplifier. As the voltage at the junction of resistors R401, R402 and R403 increases, such voltage is applied to the gate of triac Q401. In the event voltage exceeds a predetermined threshold set by triac Q401, triac Q401 conducts and becomes a direct short between IN+ and IN−, to provide a dead short. This functions to immediately result in a current in primary side P that exceeds the rating of fuse F1 (FIG. 4), which blows fuse F1 so as to cut off the supply of input power to power supply 24.

In the event over-voltage protection circuit board 74 is assembled improperly, e.g. inserted backward within the slot in power supply circuit board PSB, transistor Q402 acts as a zener diode and immediately fires triac Q401 to provide a short between IN+ and IN−.

Resistor R403 and capacitor C401 provide a time delay, e.g. on the order of 0.5 to 1 seconds, in the event of a quick spike of over-voltage in the power supply circuit, due to the time that it takes capacitor C401 to charge. In any such voltage spike situation, capacitor C401 discharges to zero through transistor Q402 into blanket heating wire W. Capacitor C402 and resistor R405 provide a filter network to prevent false triggering, to prevent exposure of triac Q401 to fast pulses.

While the various aspects of the power supply of the present invention are shown in combination, it is understood that certain aspects may be used independently of others or in various subcombinations, and in various applications. Further, while power supply 24 is shown and described in connection with an electric blanket, heating pad or throw, it should be understood that the power supply of the present invention may be used in any application in which it is desired to output controlled low voltage output power from a high voltage power input.

Various alternatives and embodiments are contemplated as being within the scope of the following claims particularly pointing out and distinctly claiming the subject matter regarded as the invention.

I claim:

1. A resistive heating device, comprising:
a power supply having a power output;
one or more resistive heating elements interconnected with the power output;
a controller interconnected with the power supply for controlling operation of the power supply; and
a load sensing arrangement interconnected with the controller and the power output of the power supply, wherein the load sensing arrangement is operable to detect resistance of the one or more heating elements and to cut off the supply of power to the controller when the resistance of the one or more heating elements exceeds a predetermined threshold.

2. The resistive heating device of claim 1, wherein the power output and the one or more resistive heating elements include a removable connection arrangement such that the one or more resistive heating elements are selectively engageable with the power output, and wherein the load sensing arrangement is operable to sense the connection of the one or more resistive heating elements to the power output, wherein the load sensing arrangement is operable to supply power to the controller when the one or more resistive heating elements are connected to the power output, and to prevent operation of the controller when the one or more resistive heating elements are disconnected from the power output.

3. The resistive heating device of claim 2, wherein the power supply includes a high voltage power input and a power conversion device that converts high voltage input power to low voltage power supplied to the power output, wherein the power input and the power output are electrically isolated from each other, and wherein the controller is interconnected with the low voltage power output of the power conversion device, wherein the load sensing arrangement is operable to cut off the supply of low voltage power to the controller from the low voltage power output of the power supply when the one or more resistive heating elements are disconnected from the power output.

4. The resistive heating device of claim 3, wherein the one or more resistive heating elements provide variations in resistance in proportion to variations in temperature.

5. The resistive heating device of claim 4, wherein the one or more resistive heating elements have positive temperature characteristics such that resistance of the one or more resistive heating elements increases in proportion to an increase in temperature, and wherein the load sensing arrangement includes a voltage reference which corresponds to a maximum temperature of the one or more resistive heating elements.

6. The resistive heating device of claim 5, wherein the load sensing arrangement includes a logic circuit responsive to the voltage reference which functions to discontinue the supply of power to the controller when resistance of the one or more resistive heating elements exceeds a predetermined threshold corresponding to the maximum temperature of the one or more resistive heating elements.

7. In a resistive heating device such as an electric blanket, heating pad or throw having a resistive heating element and a power supply for supplying power to the resistive heating element to generate heat, the improvement comprising a controller interconnected with the power supply for controlling the output of the power supply to control the heat generated by the resistive heating element, and a load sensing arrangement interconnected with the controller and with the one or more resistive heating elements, wherein the load sensing arrangement is configured to detect the resistance of the one or more heating elements and to prevent the supply of power to the controller when the resistance of the resistive heating element exceeds a predetermined threshold.

8. The improvement of claim 7, wherein the resistive heating element and the power supply include a connection arrangement that enables the one or more resistive heating elements to be selectively engaged with the power supply, and wherein the load sensing arrangement is operable to enable operation of the power supply when the one or more resistive heating elements are connected to the power supply and to disable operation of the power supply when the one or more resistive heating elements are disconnected from the power supply.

9. The improvement of claim 8, wherein the one or more resistive heating elements are constructed of a material that varies resistance according to variations in temperature, wherein the load sensing arrangement is operable to detect the resistance of the one or more resistive heating elements and to discontinue the supply of power to the one or more resistive heating elements when the resistance of the one or more resistive heating elements reaches a predetermined threshold corresponding to a maximum temperature of the one or more resistive heating elements.

10. The improvement of claim 9, wherein the power supply includes a power conversion device having a primary high voltage side interconnected with a high voltage power source and an isolated low voltage power output, wherein the connection arrangement is configured to provide removable connection of the one or more resistive heating elements with the low voltage power output of the power supply.

11. The improvement of claim 10, further comprising a low voltage power input interconnected with the low voltage power output of the power conversion device for supplying low voltage power to the controller, and wherein the load sensing arrangement is interconnected with the low voltage power input to the controller for selectively discontinuing the supply of power to the controller in response to disconnection of the one or more resistive heating elements or in response to an increase in resistance of the one or more resistive heating elements above the predetermined maximum temperature.

12. A method of operating a power supply adapted to supply power to a resistive heating load, comprising the steps of:
interconnecting a controller with the power supply to control output power of the power supply which is supplied to the resistive heating load;
detecting connection of the resistive heating load to the power supply and detecting the level of resistance of the resistive heating load, wherein the level of resistance of the heating load corresponds to the temperature of the heating load; and
discontinuing the supply of output power from the power supply in the event the resistive heating load is disconnected from the power supply or the resistance of the resistive heating load exceeds a predetermined threshold corresponding to a predetermined maximum temperature of the resistive heating load.

13. The method of claim 12, wherein the step of discontinuing the supply of output power from the power supply is carried out through the controller.

14. The method of claim 13, wherein the step of discontinuing the supply of output power from the power supply through the controller is carried out by cutting off the supply of power to the controller from the power supply.

15. The method of claim 13, wherein the step of detecting the connection of the resistive heating load to the power supply and detecting the level of resistance of the resistive heating load is carried out by detecting power output to the resistive heating load from the power supply independent of the supply of output power to the controller.

16. The method of claim 15, wherein the resistive heating load is constructed of a material that varies in resistance in accordance with variations in temperature of the resistive heating load, and wherein the step of discontinuing the supply of output power from the power supply when resistance of the resistive heating load exceeds a predetermined threshold is carried out by comparing voltage of power supplied to the resistive heating load against a reference voltage.
